(19) United States
(12) Patent Application Publication
(10) Pub. No.: US 2026/0202935 A1
(43) Pub. Date: Jul. 16, 2026

(54) INTEGRATED MULTI-SENSOR SYSTEM FOR VEHICLE

(71) Applicant: UUSI, LLC, Reed City, MI (US)

(72) Inventors: David W Baarman, Fennville, MI (US); Edward J. Cox, II, Marion, MI (US); Douglas M. Warnke, Cadillac, MI (US)

(21) Appl. No.: 19/020,082

(22) Filed: Jan. 14, 2025

(51) Int. Cl. G06F 3/041; B60R 19/52; B60R 25/24; G06F 3/044

(52) U.S. Cl. CPC G06F 3/04186; B60R 19/52; B60R 25/24; G06F 3/044; G06F 2203/04104

(57) ABSTRACT

A vehicle keyless entry system with a capacitive touch sensor system and a control unit configured to allows multipoint sequential and simultaneous input and to apply probabilistic algorithms to touch input to facilitate high probability recognition of legitimate input sequences despite adverse weather conditions, human error and other varying environmental conditions. These algorithms may, for example, determine touch input based on assessment of readings from a plurality of sensors over time and/or from a range of differently tuned input signals. The system may include a multi-sensor array using different sensor systems to provide enhanced convenience, improved operation and/or additional functionality. Key FOB systems, proximity sensor systems and/or cameras may be incorporated to enhance efficiency and/or to provide ADAS functionality. The keyless entry system may be implemented as a single unit or single chipset with dedicated sensors and input components integrated into a single unit that is easily installed and replaced.

### BACKGROUND OF THE INVENTION

The present invention relates to vehicle entry systems, and more particularly to integrated sensors arrays and related control methods.

The development of keyless entry technology for vehicles represents a significant advance in automotive convenience and security. As the technology has evolved, a wide range of alternative keyless entry systems have been developed utilizing different technology platforms. Major vehicle manufacturers offer keyless entry solutions ranging from remote entry systems, such as handheld transmitters and key FOBs, to integrated on-vehicle entry systems, such as mechanical keypads and capacitive sensors or sensor arrays. Some keyless entry systems are active (requiring action from the user to unlock the vehicle) and others are passive (unlock the vehicle upon grasping of the door handle). The use of keyless entry systems has grown to the point where they are ubiquitous and available in nearly all newly manufactured consumer and commercial vehicles.

One popular approach is to use entry and exit sensors to create a reliable keyless entry system. These systems often incorporate a capacitive sensor or sensor array that functions essentially like a keypad allowing the vehicle to be unlocked through one or more touches. The integration of capacitive touch sensors into automotive keyless entry systems marked a departure from traditional mechanical keys and even early electronic systems which relied on buttons or infrared technology. In some applications, additional convenience and security is provided by combining input from a key FOB or transponder with input from a capacitive sensor or sensor array. With these types of systems, the vehicle can be configured to automatically open the door when a user touches the door handle and the key FOB is within sufficient proximity. While these types of systems are typically easy to use and provide a high level of security can convenience, some complications can arise with the use of capacitive sensors. To illustrate, environmental conditions, such as weather events that cause ice, snow and water build up, can impact the performance of the capacitive sensor systems. This issue arises due to the inherent operating principles and environmental sensitivities of capacitive sensors. For example, snow and ice have different dielectric properties compared to air, which can alter the capacitance readings even when no user is touching the sensor. This can lead to false readings or failure to operate when actually touched. As another example, snow and ice build up can create a physical barrier that inhibits the sensor's ability to detect the capacitance changes induced by a human hand. For practical reasons, variations in temperature and the introduction of excessive moisture and condensation can also interfere with proper operation of capacitive sensors.

Efforts have been made to overcome these issues. For example, in some applications, efforts have been made to strategically place the sensor(s) in a location on the vehicle where they are less likely to be impacted by weather. Other efforts include enhanced calibration and/or isolation techniques to improve discrimination between human interaction and ice/snow/water. Human error, such as light touches and misaligned touches, can also negatively impact operation of conventional touch systems. Efforts to address touch-errors have been implemented as well, such as utilizing specific separation of the capacitive elements to isolate touch detection. Although these methods are helpful for enhancing reliability, they have limitations in use and potential reliability issues under various circumstances.

Accordingly, there remains room for improvement in the field of vehicle-integrated keyless entry system and related entry and exit sensors.

### SUMMARY OF THE INVENTION

A vehicle entry system is provided with a multi-sensor array and enhanced control methods that in different embodiments provide enhanced convenience, improved operation and/or additional functionality.

In one embodiment, a vehicle handle is provided with capacitive multi-element touch sensing. The touch elements can be located anywhere on the handle, including the top, bottom, inside, outside or a mix of these for specific secure multipoint entries. In one embodiment, the capacitive elements are arranged in an array in which the elements are separated from one another, but close enough for touch interactions on one element to affect one or more of the adjacent touch element.

In one embodiment, a touch control system is embedded within one or more vehicle trim elements. The trim element may include subtle indications for each of the touch elements to enable controls for the vehicle.

In one embodiment, the control system includes combination multipoint sequential and multipoint simultaneous input for high probability recognition. Touch input may include essentially any sequence of touches or swipes, such as swipe left, swipe right, swipe up, swipe down, back-and-forth swiping. Touch input may additionally or alternatively include multiple simultaneous and/or sequential touches for a simple swipe sequence of multi-element predictive high probability sensing.

In one embodiment, the control system allows for a combination of various multipoint simultaneous inputs for high probability recognition. For example, a sequence of two “buttons” touched, then three and then four may form an access code. As another example, a sequence of a swipe then two buttons and then three buttons and then a swipe may form an alternative access code.

In one embodiment, the keyless entry system includes a control system configured to use predictive analysis of the input sequence to determine when the input sequence is legitimate even if the access sequence does not strictly comply with the access code. By combining sequences of multi-touch and swipe interactions, the control system will increase reliability through enhanced probabilities.

In one embodiment, the control system is configured to obtain and analyze sensor readings across multiple sensors for each input attempt (e.g., each touch or swipe), whereby a combination of sensor readings can be considered to detect an expected touch even if strict compliance with anticipated sensor readings did not occur. For example, if an individual sensor is covered in snow or ice to the degree that it interferes with the control systems ability to obtain a correct reading from that sensor, the control system may analyze the readings from one or more of the other sensors to determine that a correct entry was indeed attempted.

In one embodiment, the control system is configured to monitor capacitive sensor elements for touch inputs for a legitimate access attempt using a two-mode approach. During the first mode (or “isolated mode”), the control system analyzes sensor data from the capacitive sensors element on an element-by-element basis to identify touch inputs at an element based on the sensor readings from that element. During the second mode (or “redundancy mode”), the control system uses a redundancy-enabled analysis in which sensor data from a plurality of capacitive elements are considered in combination to identify touch inputs.

In one embodiment, the control system is configured to operate primarily in isolated mode and to engage redundancy mode when the entry sensed touch sequence is sufficiently close to a legitimate access code. For example, if the control systems recognizes the beginning sequence of inputs for a legitimate access code, but then determines that the input deviates from the expected legitimate access code, the control systems may analyze sensor data collected from sensor elements adjacent to an expected sensor element to potentially reassign a legitimate value to the errant input. This may, for example, allow the control system to identify a legitimate touch entry even when a sensor element is covered by snow or ice, or when the user does not properly touch the expected sensor.

In one embodiment, the keyless entry system includes different types of sensors that are evaluated in combination to sense input attempts. For example, in one embodiment, the system may include capacitive touch system(s), camera(s), radar systems and ultrasonic sensor(s) that sense multiple cross sensor input to verify a complex sequence of events and provide feedback to the user.

In one embodiment, the touch area or input field does not have specific sensor locations, but instead uses an array of sensors and mathematically “repositions” and/or “resizes” the sequence accordingly. For example, the control system may use transformation geometry on the sensed data inputs to allow for variations in the size, position and/or orientation of inputs made through the array of sensors. In one embodiment, the control system includes conventional translation algorithms for normalizing input sequences, such as rotation, scaling and translation.

In one embodiment, the keyless entry system includes an exit assistance system that uses distance sensing to provide feedback upon opening of a vehicle door. The distance sensor(s) may be any suitable radar sensor(s), ultrasound sensor(s), camera(s) or combination thereof. The distance sensor(s) may be integrated into the door and/or into the trim around the door. To prevent opening the door into an object, the exit assistance system may provide a warning when an object is present in the sweep of the door. The system may provide a warning, such as haptics, sound, light and color sequences. The warning may be presented alternatively or additionally using other vehicle components, such as lights, sound system, horn and haptic feedback systems. In one embodiment, the door may be provided with a swing-limiting system that allows the door to open, but not far enough to abut an object. This will help to prevent damage to the door and to the object.

In one embodiment, the distance sensor(s) used for exit assistance may be multimode sensor(s) that can be used for alternative purposes while driving. For example, when the distance sensor is a radar sensor, the radar sensor may be reconfigured to detect moving obstacles (e.g., people, cars, bikes and/or motorcycles) and the capacitive touch sensor(s) can detect a car jacker attempting to open the door. To implement the foregoing, the radar sensor (or sensors) may be configured to operate differently for entry than for obstacle detection, and/or differently when the vehicle is stationary or moving at different speeds, such as different modes of operation when stopped, when moving slowly or when moving rapidly. In one application involving radar sensor(s), the range, the frequency, the wavelength, velocity resolution, angle resolutions, pulse repetition frequency, pulse width, antenna gain, beamwidth, receiver sensitivity, chirp bandwidth and signal processing algorithms may be different between different modes of operation.

In one embodiment, the keyless entry system includes the combination of a key FOB detection and radar to enable a fast-open sequence and possibly other actions, such as activating warnings, additional lights and additional security measures. For example, when a person carrying a legitimate key FOB approaches the vehicle rapidly (as determined by radar/ultrasound/other distance sensor(s)), the system may enable the doors to be opened very quickly with a simple gesture, such as a single swipe in a designated direction or a back-and-forth swipe in proper sequence.

In one embodiment, the keyless entry system may include distance sensor(s) (e.g., radar sensors/ultrasonic sensors/cameras) configured to sense approaches to the vehicle from all sides, and to enable specialized security options based on environmental factors. For example, recognition of a second person approaching the vehicle may implement a security mode in which a first input sequence opens all car doors (e.g. the second approaching person is friendly) and a second input sequence opens only the door at which the input sequence is entered (e.g. the second approaching person is unknown and potentially unfriendly). This and other security modes may be implemented based on environmental factors to provide an extra layer of security that could, for instance, prevent a would-be car jacker from entering a door that would normally be unlocked automatically with the access sequence.

In one embodiment, the keyless entry systems includes sensors that are integrated into a vehicle badge, such an OEM emblem, logo or other label. For example, a badge may be fitted with a plurality of capacitive sensor elements and one or more distance sensors (e.g., radar sensors, ultrasonic sensors). Badges are often located near or on the hood, trunk/lift gate, and doors, and accordingly can be configured to provide control of any vehicle features associated with proximate or remote vehicle components.

In one embodiment, the keyless entry systems includes sensors that are integrated into a side view mirror. For example, a side view mirror may be fitted with a plurality of capacitive sensor elements and one or more distance sensors (e.g., radar sensors, ultrasonic sensors, cameras). In these embodiments, the touch elements may be physically located on the top of the mirror housing, outside the mirror housing, inside the lip of the mirror housing, along the attachment arm/structure or any combination thereof.

In one embodiment, the keyless entry systems includes sensors that are integrated into a car pillar or trim element. For example, touch elements may be integrated into the A-pillar, the B-pillar or the C-pillar, or integrated into a trim element fixed to the exterior of the vehicle. This implementation may be used in place of a side view mirror in some applications. For example, the sensor arrangement may include one or more cameras that cooperate with a display screen to provide a view of the area typically covered by a side view mirror.

In one embodiment, the present invention provides a single PCBA system with integrated radar and capacitive elements working together for sequenced entry. In one embodiment, the present invention may provide a chipset for touch, ultrasonic and radar processing.

The current embodiments provide a variety of improvements to keyless entry systems. Some implementations of the present invention use probability analysis to affirm input attempts without strict compliance to the underlying access code. This functionality is made possible in some applications by the use of more complex input strings that include single and multitouch sequences in which a limited number of deviations for the expected input sequence can be ignored with a high degree of reliability through the use of probabilistic analysis of other aspects of the input string. Additionally, or alternatively, an analysis of readings across a plurality of sensors can be used to reliably determine when an unexpected input can be reassigned the expected value.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and are being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is an illustration showing a vehicle with a keyless entry system in accordance with an embodiment of the present invention.

FIG. 2 is an illustration similar to FIG. 1 showing the entry of a multipoint touch sequence.

FIG. 3 is an illustration showing a vehicle badge with an integrated keyless entry system.

FIG. 4 is an illustration showing a vehicle with a keyless entry system having a proximity sensing system sensing an approaching individual.

FIG. 5 is an illustration showing a vehicle with a keyless entry system having a proximity sensing system sensing adjacent objects.

FIG. 6 is an illustration showing a keyless entry system with a warning system that provides feedback relating to objects in the door swing.

FIG. 7 is an illustration showing potential places to integrate warning systems that provide feedback relating to objects in the door swing.

FIG. 8 is an illustration showing a vehicle with a keyless entry system having a radar system that provides ADAS functionality when the vehicle is in motion.

FIG. 9 is an illustration showing a vehicle with a keyless entry system having a radar system that provides ADAS functionality when the vehicle is in motion.

FIG. 10 presents probability calculations relating to system reliability.

FIG. 11 is a schematic representation of a keyless entry system with integrated radar antenna.

FIG. 12 is a schematic representation of a door handle with integrated capacitive touch system.

FIG. 13 is a schematic representation of an alternative keyless entry system with integrated camera and radar antenna.

FIG. 14 is a schematic representation of an alternative keyless entry system with integrated camera, radar antenna and ultrasonic transducer.

FIG. 15 is a schematic representation of an alternative keyless entry system integrated into a side view mirror.

FIG. 16 is a schematic representation of an alternative keyless entry system with integrated camera that can be installed in place of a side view mirror.

FIG. 17 is an illustration used in describing proximity sensing with proximity sensors and capacitive sensors.

FIG. 18 is an illustration used in describing more distant proximity sensing with proximity sensors and capacitive sensors.

FIG. 19 is a schematic diagram of a keyless remote entry system.

FIG. 20 is a schematic diagram of a capacitive sensor system.

FIG. 21 is a schematic diagram of a radar system.

FIG. 22 is a schematic representation of a system for limiting the opening position of a lift gate.

FIG. 23 is a schematic representation of a system for limiting the opening position of a side door.

### DETAILED DESCRIPTION OF THE CURRENT EMBODIMENTS

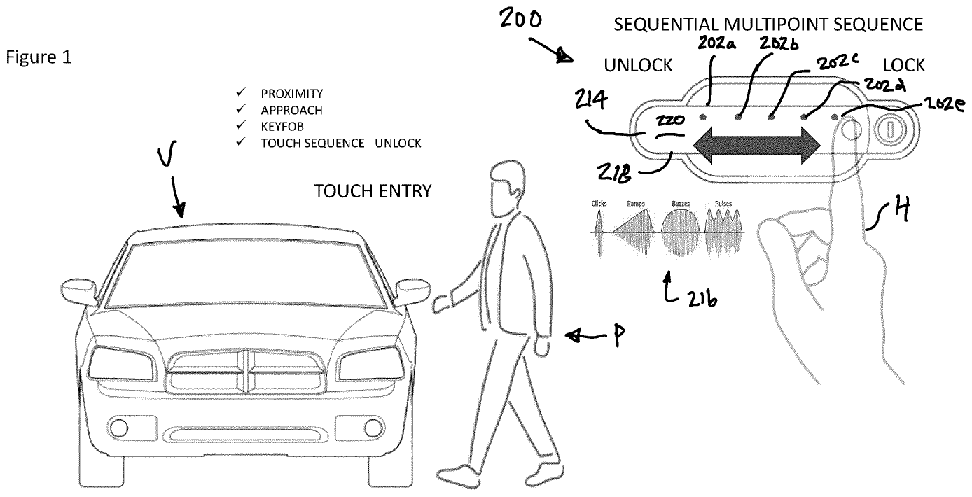

The present invention is directed to an integrated multi-sensor keyless entry system for a vehicle. In various alternative embodiments, the present invention provides improved keyless entry systems that, generally speaking, use multiple integrated sensors and/or enhanced control methodologies to provide improved convenience, added functionality and/or advanced security. Various alternative embodiments of the present invention are shown in FIGS. 1-14.

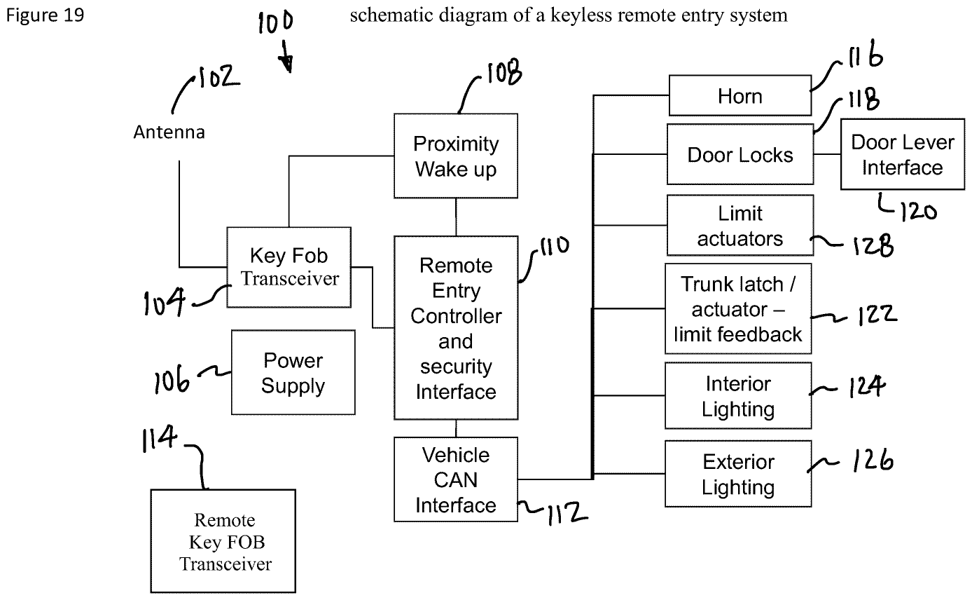

FIG. 19 is a schematic diagram of a remote keyless entry system 100 that is made of a combination of systems in accordance with an embodiment of the present invention. As shown, the remote entry system 100 generally includes an antenna 102, a vehicle key FOB transceiver 104, a power supply 106, a proximity wake up component 108, a remote entry controller and security interface component 110, a vehicle CAN interface 112 and a remote key FOB 114. FIG. 19 is a schematic diagram that represents an embodiment of the present invention in functional blocks. This schematic diagram is not intended to limit implementation of the present invention to any specific hardware/software configuration. Instead, the present invention may be implemented in a single-controller implementation in which a single controller manages all system functions or it may be implemented in a multi-controller distributed implementation in which different controllers are responsible for different functional blocks.

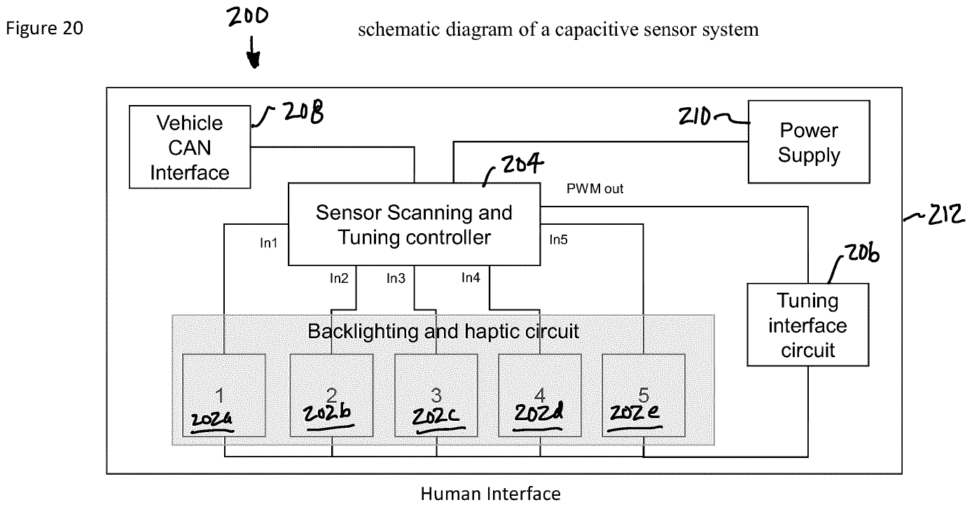

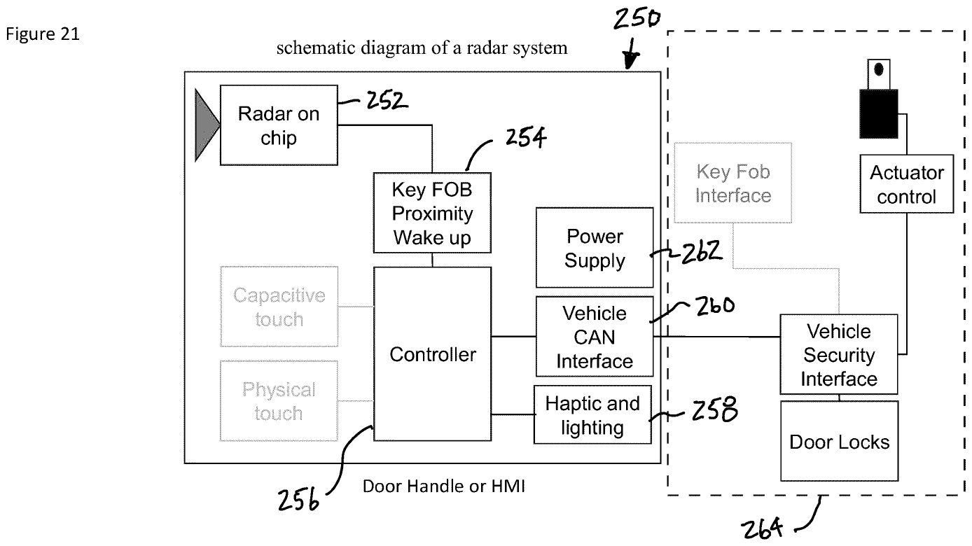

In this embodiment, the remote key FOB 114 interfaces with the remote entry system 110 to control systems like the horn 116 (e.g. audible feedback and alarm), door locks 118, door lever interface 120, trunk lock 122 (latch/actuator), interior lighting 124 and exterior lighting systems 126. The system controls various aspects of these sequences and responses. In operation, remote key FOB 114 proximity may trigger lighting systems and may be used to enable other systems like the capacitive sensor system shown in FIG. 20 and the radar system shown in FIG. 21. As an example, the remote key FOB 114 may be provided with several keys for door unlock and trunk unlock. It may also interface to the vehicle security system for an alarm. This brings in the system interface with exterior lighting 126, like the headlights and taillights, it also interfaces to the horn 116 and can alternate horns and lighting to bring attention to the vehicle. When the remote key FOB 114 approaches the vehicle key FOB transceiver 104, the system may automatically initiate entry lighting, this can also be initiated by opening the doors or trunk. The vehicle key FOB transceiver 104 interfaces to the vehicle entry and security system that in turn has connections to these other devices and sub systems. In the illustrated embodiment, the key system is implemented using generally conventional techniques and apparatus, though the key FOB system may be customized to include additional and alternative functions as set forth herein.

In the illustrated embodiment, the remote entry controller and security interface component 110 include a capacitive sensor system 200, such as the embodiment shown in FIG. 20, and a radar system 250, such as the embodiment shown in FIG. 21. Although discussed in more detail below, the capacitive sensor system 200 generally includes a plurality of capacitive sensors 202a-e, a sensor scanning and tuning controller 204, a tuning interface circuit 206, a vehicle CAN interface 208 and a power supply 210. In the illustrated embodiment, the capacitive sensors 202a-e are arranged in a region (or touch input field) that may include backlighting and haptic feedback, as desired. In operation, the sensor scanning and tuning controller 204 applies appropriate output signals to each of the capacitive sensors 202a-e and monitors the input signals returning from each capacitive sensors 202a-e to monitor for touch interactions. The output signal in the illustrated embodiment is a pulse width modulated (“PWM”) signal. The characteristics of the PMW signal may be tuned, for example, using a tuning interface circuit 206 to tune the PMW signal to enhance the impact that touch inputs have on the signals returning from the capacitive sensors 202a-e. For example, the frequency, duty cycle, amplitude, signal rise and fall time, and/or other characteristics of the PWM signal may be varied to enhance the impact of touch inputs. If desired, the tuning interface circuit 206 may also include filters, such as low-pass filters, to smooth the PWM signal and potentially provide enhanced performance. In an effort to optimize performance under different operating or environmental conditions, such as (a) touch inputs made on a dry input field, (b) touch inputs made on a wet input field, (c) touch inputs made with ice formed on the input field and/or (d) touch inputs made while wearing gloves, the signal applied to the capacitive sensors 202a-e may repeatedly cycle through different characteristics, where each set of characteristics is selected to optimize the impact of touch inputs under a corresponding operating/environmental condition. These particular conditions are merely exemplary and the PWM signal may be varied to optimize performance under alternative or additional operating/weather conditions. The appropriate tuning characteristics for different conditions may be determined by testing the system in a controlled environment to identify the characteristics of the PWM signal that provide the best performance under each condition.

As noted above, the sensor scanning and tuning controller (“SST controller”) 204 monitors the input signals returning from each capacitive sensor 202a-e to monitor for touch interactions, which may include touches, multi-touches, gestures and/or combinations of touches and gestures. As used herein, the term “touch” is used referred to refer to interactions that do not involve moving a finger while it is contact with the touch input field, while the term “gestures” is used to refer to interactions that involve movement of a finger over the touch input field. In the illustrated embodiment, the SST controller 204 may use probabilistic techniques to improve accuracy and enhance performance over a wide range of changing environmental conditions. For example, the SST controller 204 may include noise filtering and signal processing circuitry that utilize probabilistic models, such as Bayesian filtering, to distinguish actual signals from noise. The probabilistic model may be based on previous readings/historical data, which may include data collected in controlled testing environments. The SST controller 204 may also use one or more probabilistic threshold determination models that assists in discriminating between touch interactions from non-touch events. The threshold determination model may analyze historical data to identify the likelihood that real-time capacitance readings are associated with touch interactions rather than non-touch events. If desired, the SST controller 204 may implement an adaptive sensing algorithm in which probabilistic models are used to adapt the sensitivity based on environmental or user interactions. This may include analyzing historical sensor data during different environmental conditions, such as rain, sleet, snow and dry conditions, to allow the probability thresholds to be adjusted when encountering different environmental conditions. The adaptations to probability thresholds may be based on external sensors, such as temperature, humidity and rain sensors, and/or based on information derived from the capacitance readings. For example, the presence of specific noise patterns in the sensor readings may signal the presence of snow, sleet, ice, high humidity, which may be used by the SST controller 204 to vary the characteristics of the PWM signal and/or to change the probability thresholds associated with touch interactions. The SST controller 204 may also implement algorithms that combine the inputs from multiple sensors to improve accuracy. For example, probabilistic algorithms that fuse data from multiple sensors can be used to overcome environmental factors, such as snow, ice or water, which might negatively impact the readings at an individual capacitive sensor. Additionally or alternatively, the SST controller 204 may implement a detection algorithm that uses probabilities in a machine learning algorithm to classify different types of touches or gestures. A properly trained model with a dataset of capacitance readings and corresponding touch interactions can help in improving the accuracy of estimates of the probability of a specific touch or gesture based on real-time sensor readings. If desired, the system may be configured to require touch input sequences that enhance the probability of recognition. For example, multi-touch entries and input gestures that extend over a plurality of capacitive sensor elements have the potential to have a significant impact on the reliability of the system because readings from a plurality of capacitive touch elements can be taken into account in determining whether an expected touch entry took place. As one example, when an individual capacitive touch element is not reading properly due to weather (snow and/or ice) or other adverse conditions, the readings from adjacent elements may be used to determine that a legitimate touch entry was made. If desired, the SST controller 204 may be configured to monitor capacitive touch elements 202a-e for touch inputs for a legitimate access attempt using a two-mode approach. During the first mode (or “isolated mode”), the SST controller 204 analyzes readings from the capacitive touch elements 202a-e on an element-by-element basis to identify touch inputs at a specific element based on the readings from that element. During the second mode (or “redundancy mode”), the SST controller 204 uses a redundancy-enabled analysis in which readings from a plurality of capacitive elements are considered in combination to identify touch inputs. The SST controller 204 may generally operate in isolated mode and switch to redundancy mode when a legitimate touch entry was not recognized in a given collection of readings. For example, the SST controller 204 may first parse the data collected from the readings in isolated mode and, if no legitimate touch entry is identified, the SST controller 204 may reparse the data in redundancy mode. The SST controller 204 may be configured to enter redundancy mode only when the determined input is close enough to being correct to warrant further consideration. For example, if the SST controller 204 recognizes the beginning sequence of inputs for a legitimate access code, but then determines that the input deviates from the expected legitimate access code, the SST controller 204 may analyze sensor readings collected from one or more sensor elements adjacent to an expected sensor element to potentially reassign a legitimate value to the errant input. If the sensor readings collected from one or more adjacent touch elements are sufficiently consistent with the readings expected for a legitimate touch entry, the SST controller 204 may proceed as though the legitimate touch entry was made. This may, for example, allow the SSCT controller 204 to identify a legitimate touch entry even when a sensor element is covered by snow or ice, or when the user does not properly touch the expected sensor.

In the embodiment illustrated in FIGS. 19-21, the remote keyless entry system 100 also includes a radar system 250. The radar system 250 is optional and may be eliminated in alternative embodiments of the present invention. The illustrated radar system 250 includes a radar-on-chip (“RoC”) integrated circuit (“IC”). Examples of potentially suitable RoC ICs includes Texas Instrument's IWR6843 RoC IC and Infineon's BGT24Atr24 RoC IC. Other suitable RoC ICs are available from NXP. The RoC combines the components of a radar system, such as transmitters, receivers, transceivers, signal processors and antennas, onto a single chip. In the illustrated embodiment, the radar system 250 includes radio frequency (“RF”) circuitry, but alternative systems may operate using alternative signal types, such as ultrasonic sensors, infrared sensors, LIDAR (light detection and ranging) sensors, vision-based systems (cameras) and/or hybrid systems that combine two or more different sensor types. The radar system 250 of the illustrated embodiment may be configured to provide short-range radar (“SRR”), mid-range radar (“MRR”) and/or long-range radar (“LRR”). SRR may operate in the 24 GHz range, while MRR and LRR may operate in the 77-81 GHz range. Though the frequency ranges may vary from application to application. When implemented, the RoC IC 252 may be dedicated for use with the remote keyless entry system 100 of the present inventio or it may be shared with other advanced driver-assistance systems (“ADAS”) for functions like collision avoidance, adaptive cruise control and parking assistance. When implemented as a shared system, the RoC IC 252 may communicate with one or more systems using a generally conventional CAN network.

Referring now to FIG. 1, the present invention includes a capacitive sensor system 200 with a capacitive touch array 202a-e that is integrated into a vehicle, such as into a door handle or into a trim element. The left portion of FIG. 1 shows a person P approaching a vehicle V in anticipation of operating the capacitive sensor system 20. The right portion of FIG. 1 shows the person's hand H interacting with the touch input field 214. The capacitive sensor system 200 may include a haptic circuit (See, for example, FIG. 20) that provides different haptic feedback signals 216 in response to user inputs, such as the clicks, ramps, buzzes and pulses shown in FIG. 1. In the exemplary embodiment shown in FIG. 20 shows the capacitive sensor system 200 generally includes a plurality of capacitive elements 202a-e arranged to form the capacitive touch array arranged in a touch input field 214, a control unit (See, for example, FIG. 20, Sensor Scanning and Tuning Controller 204) that monitors the capacitive elements 202a-e, a power supply 210 and a housing 212. In this embodiment, the sensors (or sensor elements) 202a-e can be scanned by the control unit at a high rate while the control unit varies the tuning via the tuning interface circuit (See, for example, FIG. 20, tuning interface circuit 206). By scanning the sensors while moving through various tuning sequences, the SST controller 204 can enable a higher sensitivity to various weather scenarios and other environmental variations (as described in further detail below). In some cases, additional tuning to accommodate for weather and other variations may not be needed as the system probabilities are sufficient to provide the desired level of performance. When implemented, this provides an enhanced statistical framing of the sensor data and also provides details on the conditions. The tuning would tune between, for example, a perfect day, rainy day and an icy and snowy day. The feedback and the data allow multiple scans in each of these tuning areas and identifies the day type as well as the code. The capacitive touch array includes a plurality of capacitive elements arranged in a pattern that generally covers the area on the vehicle surface where touch input is expected, which is generally referred to as the touch input field 214. If desired, the touch input field 214 and/or the individual sensor areas may be bounded by physical structures (such a raised perimeter 218) or by a graphic representation (such as an outline or change in color or texture). Each capacitive element may be formed by a conductive element, such as a conductive pad or electrode made from material like copper or conductive ink. The capacitive touch array of the illustrated embodiment also include a dielectric layer that is disposed between the conductive elements and the vehicle body. The dielectric material may be an insulating layer that ensures proper capacitive changes when a touch interaction is detected. The dielectric material may be glass, plastic or specific insulative coatings. In the illustrated embodiment, the capacitive elements are spaced apart from one another a sufficient distance to provide a level of isolation that facilitates operation. If desired, the capacitive elements may also be close enough for touch interactions on one element to affect one or more of the adjacent touch elements. This may allow the system to accurately determine a touch event on a given touch element even when that touch element is not working properly by evaluating readings from adjacent touch elements. The number and arrangement of capacitive elements may vary from application to application. For example, the capacitive touch array of FIG. 1 includes five capacitive touch elements 202a-e arranged in a single row. The number of capacitive elements may vary as desired, depending in large part on the desired size, shape and resolution of the touch input region. For example, in one alternative embodiment, the capacitive touch sensor array may include multiple rows of capacitive elements (e.g., two, three or more rows may be incorporated into alternative embodiments) to add an additional dimension to touch inputs. If desired, some form of indicia may be provided in the touch input area to assist in creating and entering touch inputs. For example, in FIG. 1, a small graphic image or surface detail is provided over each capacitive touch sensor.

The capacitive elements 202a-e are operably coupled to a control unit that is capable of sensing the capacitance or dielectric properties of the capacitive elements 202a-e and is programmed with touch input algorithms for detecting and interpreting touch inputs. In the illustrated embodiment, the control unit includes a microcontroller or a dedicated capacitive sensing integrated circuit (“IC”), such as SST controller 204 shown in FIG. 20). The control unit operatively interfaces with the vehicle's electronic systems, for example, via vehicle CAN interface 208 shown in FIG. 20. Although not shown in FIG. 1, the capacitive touch sensors 202a-e are electrically connected to the control unit 204, for example, by wires or by conductive traces, which may be embedded within flexible printed circuit boards or ribbons (See, e.g. FIG. 20).

In the illustrated embodiment, the sensor array 202a-e and its components may be covered with a protective layer 220 to shield them from the environment, such as from moisture, dust and mechanical damage. The protective layer may include one or more layers of silicone, plastic or specialized coatings. The protective layer may be painted or otherwise finished to match or contrast with the surrounding vehicle body parts. If desired, icons or other graphic representations may be provided to outline the touch input field and to provide indicia that assists in entering touch input. For example, the surface may include a series of graphic images, such as dots or a number sequence that define the touch input field and/or the individual capacitive sensor elements 202a-e. The control unit 204 may be configured to allow touch input sequences that includes any combination of single touches, single swipes, multi-touches and multi-swipes, and the indicia provided on the surface of the touch input area may facilitate touch inputs. For example, a user may use the indicia as guide in entering a touch input sequence.

In the illustrated embodiment, the keyless entry system 100 for the vehicle also includes a radar system and/or a key FOB system that assist in implementing keyless entry functions. The embodiment illustrated in FIGS. 19-21 incorporates a remote key FOB 114, a vehicle key FOB transceiver 104 (FIG. 19) and a radar system 250 (FIG. 21). When included, the keyless entry system 100 may include algorithms that incorporate radar input and/or key FOB input. For example, the radar system 250 and/or the key FOB system may be used to assist in operation of the capacitive touch system 100. In one application, the keyless entry system 100 uses input from the radar system 250 and/or the key FOB system to trigger activation of the capacitive touch system 200. This approach can be used to limit power consumption associated with the capacitive touch system 200. For example, in one implementation, the key FOB system may be used to determine when an appropriate remote key FOB 114 is within proximity of the vehicle. In the illustrated embodiment, the keyless entry system 100 includes a generally conventional key FOB system of the type generally associated with a passive keyless (“PKE”) entry system. For example, the vehicle may include a key FOB transceiver 104 that periodically sends signals at short intervals to repeatedly check for the presence of the remote key FOB 114. The polling interval may be adaptive and vary based on context. For example, the polling frequency may decrease after a given amount of time has passed or when the strength of the signal from the remote key FOB 114 has faded below a threshold. Upon receiving the polling signal from the vehicle V, the remote key FOB 114 may respond by transmitting a signal containing a coded message. When the vehicle transceiver 104 receives the return remote key FOB signal, it decodes the message and verifies whether the remote key FOB 114 is authentic. If a determination is made that the remote key FOB 114 is authentic, the keyless entry system 100 may take further action. The action taken by the keyless entry system 100 may vary from application to application and/or from context to context. In a conventional PKE system, the keyless entry system 100 may be configured to open or allow opening of the vehicle V in response to detection of an authentic remote key FOB 114. However, in the illustrated embodiment, the keyless entry system 100 uses the capacitive touch system to implement an enhanced level of security in which a legitimate access code must be input on the capacitive touch system 200 before access to the vehicle V is granted. In this way, the keyless entry system 100 prevents an unauthorized individual from opening the vehicle door merely because the remote key FOB 114 is near the vehicle V. For example, this can prevent an individual that has stolen the remote key FOB 114 from gaining access to the vehicle V and prevent an individual who has approached the vehicle V at the same time as a person carrying the remote key FOB 114 from gaining access to the vehicle V.

In this embodiment, the control unit may be configured, upon detection of an authentic remote key FOB 114, to enable operation of the capacitive touch system 200 or to enable the radar system 250 to determine when to enable operation of the capacitive touch system 200. In keyless entry systems 100 without a radar system 250, the SST controller 204 may be configured to activate the capacitive touch array 202a-e upon presence of an authentic remote key FOB 114. More specifically, the SST controller 204 may be configured to repeatedly poll the capacitive touch sensors 202a-e in an effort to obtain touch input data at any time the remote key FOB 114 is determined to be within range of the vehicle V. In keyless entry systems 100 that incorporate a radar system, the radar system 250 (rather than the capacitive touch system 200) may be engaged when the remote key FOB 114 is within sufficient range of the vehicle V. Once engaged, the radar system 250 can be used to determine when an individual approaches the vehicle V and/or comes within sufficient proximity to the capacitive input area 214. Once the desired criteria have been met, the capacitive touch sensor system 200 can be activated to begin polling the capacitive sensor array 202a-e to collect touch inputs.

The present invention may incorporate essentially any radar system capable of monitoring objects within the desired range. For example, the radar system 250 may include short-range, mid-range and/or long-range radar systems. A short-range radar system may operate in the frequency range of 24 GHz to 79 GHz and may have a distance range of up to about 30 meters. Short-range radar may be used when high resolution is desired for detecting relatively small objects with relatively precise measurements. Short-range radar systems also conventionally have a wider field of view. A mid-range radar system may operate at a frequency of about 77 GHz and may have a distance range of between about 30 to 80 meters. The frequency may, of course, vary from application to application. While mid-range radar systems generally have extended range, they typically have lower resolution and a narrower field of view than short-range radar systems. Long-range radar systems may operate at a frequency of about 77 GHz and may have a distance range of up to about 250 meters. Long-range radar systems have extended distance, but generally have a lower resolution and narrower field of view than both short-and mid-range radar systems.

In the illustrated embodiment, the radar system 250 generally includes an antenna, a transmitter, a receiver, a signal processor, a power supply and a housing. The radar system may include one or more radar antennas that transmit and receive radar signals. The radar system may include multiple antennas to form an array for beamforming and direction finding, as desired. The transmitter of the illustrated embodiment includes a signal generator (e.g., a voltage control oscillator) and one or more amplifiers. The signal generator generates and amplifies the high-frequency radar signal that is transmitted by the antenna. The receiver of the illustrated embodiment is configured to receive the reflected radar signals and convert them to a lower frequency for processing. In the illustrated embodiment, the receiver may include low-noise amplifiers, mixers and filters that prepare the received signals for processing. The signal processor is configured to process the received signals to extract the desired information, which depending on the mode of operation may include information such as distance, speed and angle of detected objects. For example, in one embodiment, the signal processor is programmed to: (a) determine the distance to an object using conventional time-of-flight algorithms that measure the time delay between the emitted and received signals; (b) determining the angle of an object using conventional beaming forming techniques (using multiple antennas); and (c) determining the relative speed of an object using conventional algorithms that use the Doppler shift in the frequency of the reflected signal. Signal processors capable of carrying out this processing are well known and will not therefore be described in detail. Suffice it to say that the signal processor may be programmed to implement Fast Fourier Transforms (“FFT”) and other conventional signal processing techniques to obtain the desired information from the received radar signals. The power supply is generally conventional and is configured to provide whatever power is needed for the components of the radar system (and potentially other components). The radar system is enclosed and protected with the housing, which is designed to withstand automotive environmental conditions. As discussed above, the radar system 250 of the illustrated embodiment is implemented by a radar-on-chip IC 252 that can allow a very small package. In this embodiment, the antenna(e) is mounted on the chip surface and is basically a complete radar package. The software and algorithms for detection and output are tested and programmed using conventional methodologies for the specific operations desired, range, velocity tracking and many other functions can be enabled with these sensors. The radar ranging enables the thresholds for the actuator that controls the door opening threshold and limits the door to below the range detected by the radar. The user may be alerted by haptic and lighting indicators.

The keyless entry system 100 may include a dedicated radar system that is used exclusively by the keyless entry system. Alternatively, the radar system associated with the keyless entry system may integrate with other vehicle systems to assist in other vehicle functions. For example, the radar system may provide information used for adaptive cruise control, collision warning, automatic braking, blind spot monitoring, lane departure warnings, parking assist and other advanced driver-assistance systems (“ADAS”) functions. In some alternative applications, the keyless entry system 100 may use radar systems integrated into other vehicle systems. For example, the keyless entry system 100 may be operatively integrated with a radar system that performs ADAS functions. In implementations of this type, the radar system may operate with the keyless entry system 100 when the vehicle is stationary and/or not running and may operate with other ADAS systems when the vehicle is running and/or in motion. In some alternative embodiments, the keyless entry system 100 may include a lidar system or obtain information from an existing vehicle lidar system. The lidar system may be used in place of or as a supplement to the radar system discussed above. When the radar system is shared, it may as noted above communicate across systems using the CAN network.

In the illustrated embodiment, the SST controller 204 is configured to repeatedly poll the capacitive senor array 202a-e and to collect data representatively of the senor array readings over a rolling period time, such as one second, two seconds, three seconds, five seconds, ten seconds, 20 seconds or thirty seconds. The SST controller 204 or a supplemental microcontroller is programmed to analyze the collected data to determine whether it includes a legitimate access code. As discussed in more detail below, the collected data may be analyzed using a variety of algorithms that attempt to overcome issues presented by weather conditions, environmental conditions or by human error. Through the use of more complex touch input sequences, for example, with multitouch or multi-swipe inputs, probability analyses may be used to accurately predict when the collected data that does not correspond with a legitimate access code should be interpreted as a legitimate access code. In the embodiment of FIG. 1, the keyless entry system uses multiple sequential capacitive elements in a multipoint sequence wherein the probabilities of each key contribute to the whole. If an element is missed or skipped, but the timing or detection is within the timing, the probability of that sequence is enhanced and recognized. The same is true of a multipoint simultaneous sequence. These can be used together for additional reliability in adverse weather conditions and other changing environmental conditions. By sampling the keys multiple times for each position and/or tuning the signal applied to the capacitive touch sensors 202a-e with different tuning points (as described elsewhere) the system 200 creates a more comprehensive picture of potential touch interactions, thereby allowing statistical analysis and associated probabilities (such as those discussed above) to be used to presume a legitimate touch entry even when not all of the data points associated with a legitimate touch entry are present. Tuning may be configured for easy and more difficult environmental conditions and the system obtain get readings and probabilities for these readings or data points (such as discussed above).

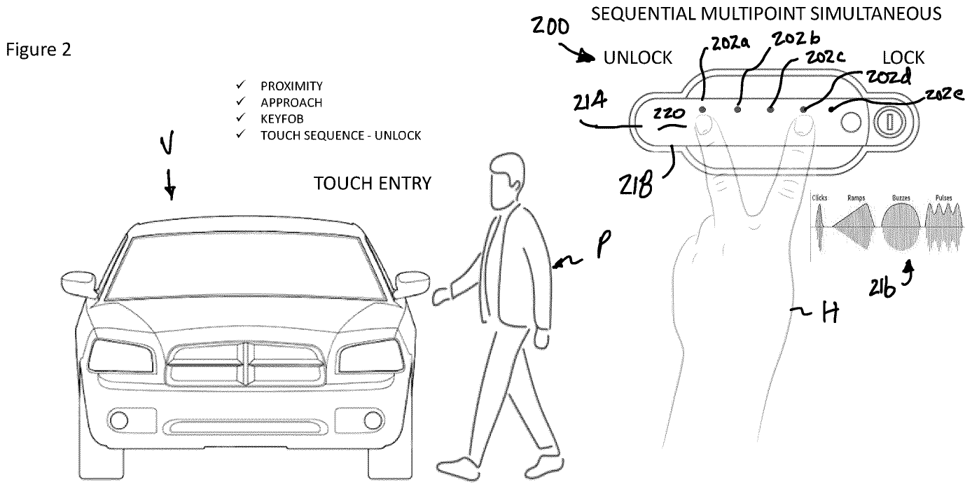

If desired, the door handle (or other keyless entry area) may have haptic and/or visual feedback for recognition and warnings. For example, vibrations and/or illuminations may be used to provide feedback to the user. Different types of haptic feedback may be used to provide different messages to the user. For example, FIGS. 1 and 2 show haptic feedback signals 216 in the form of clicks, ramps, buzzes and pulses. FIG. 1 shows the door handle with physical dots that detail the position of each sensor in a simple form. The indications (or indicia) can be small details, graphics, bumps, ridges, changes in surface treatment, undulations, trim details or other design details that can be readily noticed by the consumer. Although FIGS. 1 and 2 show the capacitive touch area 214 incorporated into a door handle, the capacitive touch area can be disposed in other locations on the vehicle. For example, the capacitive touch area can alternatively be disposed in the trim of the window with no handle required. Feedback may also facilitate entry of touch entry sequences over a time domain. For example, one entry in a touch entry sequence may include touching and holding a specific capacitive sensor for a period of time, and the haptic/visual feedback may pulse periodically while a touch is being held (e.g. each second) to assist the user in making time-based touch entries.

The use of a key FOB and/or radar system is not required in all embodiments of the present invention and even when key FOB and/or radar systems are included, the capacitive touch system 200 may operate in a low-power mode to determine when to enable full operation. In addition to, or as an alternative to, the key FOB system/radar system inputs discussed above, the capacitive touch system 200 may be enabled by periodically taking readings from the sensor array 202a-e and enabling full operation when a gross change in capacitance has been recognized. This may be useful in applications where the vehicle V does not have a key FOB system or a radar system 250, or where it is desirable to allow an individual to access the vehicle even if they do not have an authenticated remote key FOB. For example, in this embodiment, the keyless entry system may operate in a low power mode in which the control unit 204 polls the sensor array 202a-e at a relatively low periodic frequency and with a relatively low amount of power consumption. When the SST controller 204 recognizes a gross change in capacitance from one or more of the capacitive sensors 202a-e, the SST controller 204 can enable full operation and begin actively polling and collecting capacitive sensor data at the desired frequency. The user may then enter a legitimate access code to gain entry into the vehicle V or initiate other actions even if the user does not have the remote key FOB.

As noted above, the capacitive touch system 200 may be configured to receive single point or multipoint touch input. FIG. 1 is representative of a single touch system in which a sequence of individual touches and/or swipes can be used as an access code. FIG. 2 shows a system that is generally identical to the system shown in FIG. 1, and is representative of a multipoint input. As shown, an individual's hand H is using two fingers to input two input signals at the same time. Although illustrating entry of two simultaneous inputs, it should be understood that the SST controller 204 may be configured to receive an individual input or any number of simultaneous inputs. As discussed above, the SST controller 204 may be configured to obtain and collect a rolling number of sensor readings from all sensors 202a-e at the desired interval, and to analyze the readings from all sensors 202a-e to determine whether a legitimate touch input was received. While FIG. 1 illustrates a sequence of individual touches and/or swipes and FIG. 2 illustrates a multitouch input, the SST controller 204 may be configured to recognizes touch inputs that combine single touch inputs, single touch swipe inputs, multitouch inputs and multitouch swipe inputs. In typical applications, the user will be permitted to program the keyless entry system 100 or the capacitive sensor system 200 with a user-defined touch input sequence—though the control system may be configured to require the user-defined touch input sequence to be within certain parameters (e.g., include at least a predetermined number of touch inputs, include at least one single touch and at least one multi-touch, or include at least three distinct motions in a gesture input). In some applications, the system may allow the user to program different touch input sequences for different functions (e.g. different touch input sequences for unlocking just the drive side front door, for unlocking all doors, for opening the lift gate/hatch/trunk, for enabling the headlights, for sounding an alarm). In other applications, the system may allow a user to program a single touch input sequence followed by a pre-set supplemental entry to specify the desired function (e.g. enter the appropriate touch input sequence followed by one or more of the following: a “1” to unlock all doors, a “2” to open just the driver side front door, a “3” to open the lift gate/hatch/trunk, a “4” to enable the headlights, etc.). In one implementation, the system may provide haptic or visual feedback when a legitimate touch sequence is entered and then provide a specific period of time for entering pre-set supplemental entries (e.g. three seconds or five seconds).

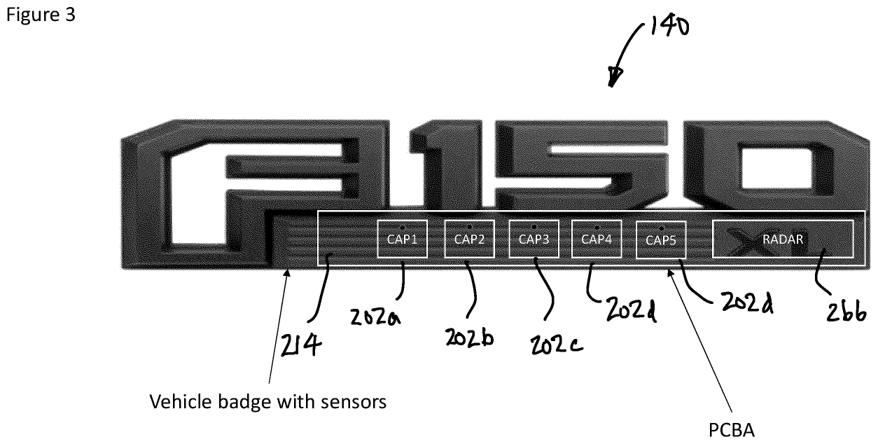

As noted above, the capacitive touch area (or touch input field) may be integrated into different locations on the vehicle. FIGS. 1 and 2 show the capacitive touch area 214 on the door handle and it is noted that the capacitive touch area may alternatively be integrated into the trim around the window. These are just examples and the capacitive touch sensor may be integrated into essentially any car pillar or trim element. For example, touch elements may be integrated into the A-pillar, the B-pillar or the C-pillar, or integrated into a trim element fixed to the exterior of the vehicle. FIG. 3 shows an alternative embodiment in which the capacitive touch area is integrated into a vehicle badge 140, such as a company logo, vehicle style name or other similar component. As shown, the badge 140 may include a plurality of capacitive touch elements 202a-e that are arranged across the touch area 214. The badge 140 may include other electronic components, such as a radar sensor or radar module disposed behind a radar window 266. In the illustrated embodiment, the badge 140 is a self-contained electronic component with a single wiring harness (not shown) that can be plugged into a corresponding plug that couples the electronic components in the badge 140 with appropriate external components, which may include the keyless entry system control unit 110 and/or the vehicle electronics to allow the desired functions, such as unlocking one or more doors, opening a tailgate or liftgate, starting the vehicle, turning on interior and/or external lights, operating a panic alarm and other desired functions.

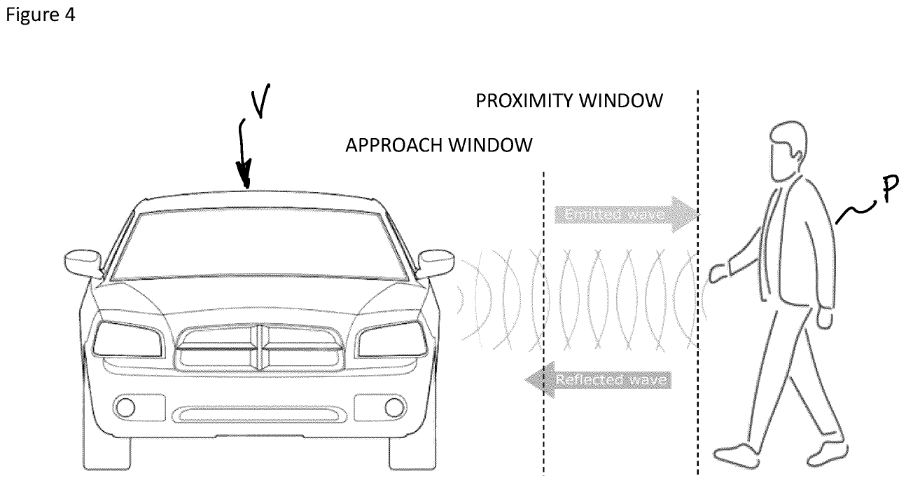

In the embodiment shown in FIG. 4, the keyless entry system may include proximity sensing. The proximity sensing system may include an ultrasonic module or a radar module built into the door handle, a trim element around the door/window or in essentially any other desired location. In these applications, the ultrasonic transceiver or radar transceiver may be housed in the door handle behind a protection covering that is transparent to the ultrasonic or radar signals. The proximity sensing system may include a separate control unit, or it may be integrated with the control unit for the keyless entry system. In operation, the control unit is configured to use the proximity sensor to detect when an individual is walking toward the capacitive touch area from any direction and understands the speed of approach. This may include analyzing the time of flight associated with the return of individual signals or a comparison of time of flight associated with sequential signals. Faster speeds may indicate urgency and slower speeds may indicate the need for assistance. The control unit may adapt the keyless entry system to function differently based on the rate of approach or other sensible characteristics. For example, if an individual carrying an authentic key FOB approaches the vehicle rapidly, the keyless entry may enable a shorter/more simple entry code. Further, the vehicle may activate a panic alarm, which may include honking the horn, flashing the lights or engaging a separate alarm incorporated into the vehicle or vehicle antitheft system. The control unit may also recognize two different windows of approach (or regions of proximity), such as a more distant proximity window and a closer approach window (shown in FIG. 4), which trigger different functions. For example, the system may operate in an extreme low power mode (e.g. slow polling frequency) configured simply to identify presence of a moving object until that object enters the proximity window after which the system increases the polling frequency and begins to analyze the speed of approach. The individual's movement from the proximity window to the approach window may trigger specific actions based on speed of approach, such as activation of a panic alarm when a high speed of approach is recognized.

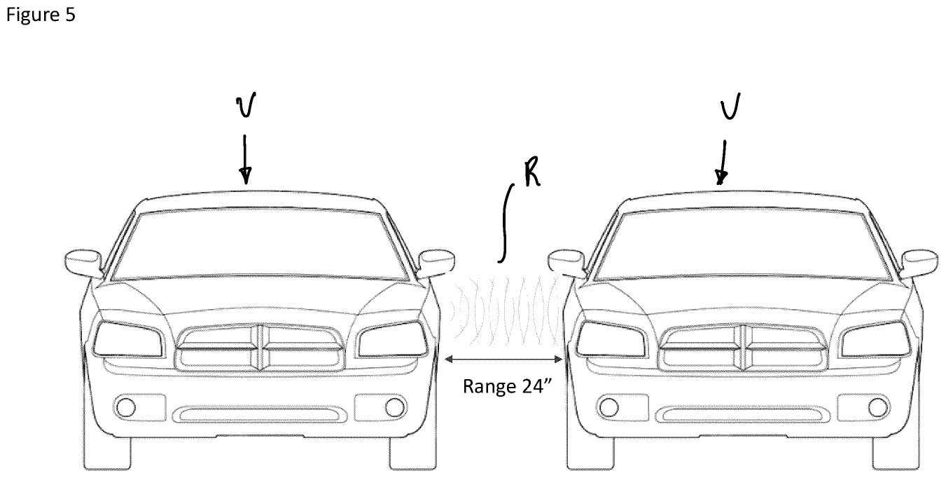

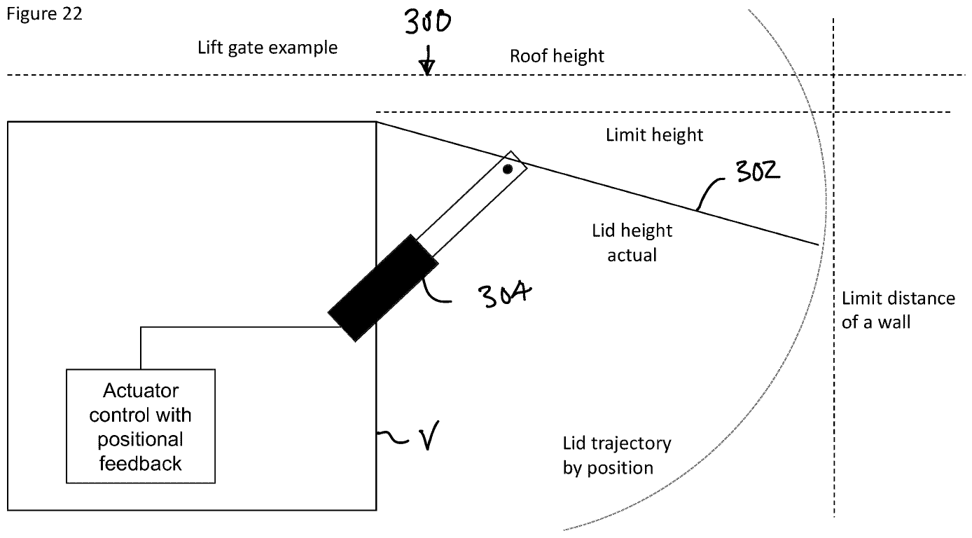

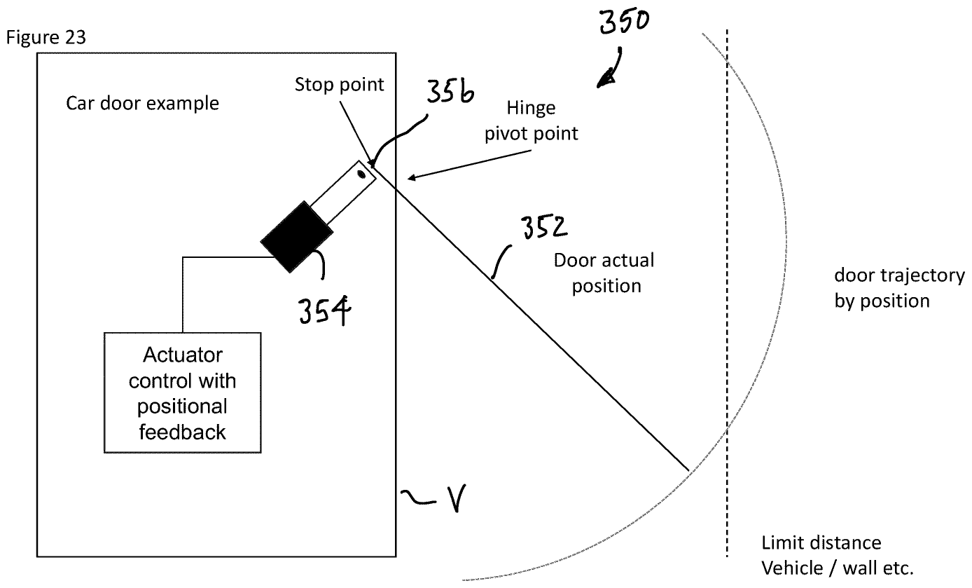

In applications that incorporate a proximity sensing system, the proximity sensing system may provide the vehicle with additional functionality. For example, FIG. 5 is an illustration of using the proximity sensing system in connection with a warning system associated with opening of the door. In this embodiment, the proximity sensing system is configured to determine whether any object are close enough to interfere with opening of the vehicle door. For example, the illustration shows two vehicles V1 and V2 that are parked next to each other at a range R, which happens to be close enough for the door of one vehicle to hit the other vehicle if fully opened. If the proximity sensing system detects an object within the swing of the door, action may be taken. The action taken may vary from application to application. In one implementation, the proximity sensing system may set off a warning if an individual touches the internal door handle when an object is in the swing of that door. The warning may be an audible alarm, a light and/or haptic feedback. In some implementations, the proximity sensing system may prevent the door from being opened into an object. For example, the proximity sensing system may prevent the door latch from opening on doors that are opened manually, may prevent automated actuators from operating on doors that open through automation (e.g. lift gates), or may allow the door to open, but take action to limit movement of the door so that the door does not abut an adjacent object. FIGS. 22 and 23 show different embodiments of door swing-limiting systems that limit movement of the door in accordance with this aspect of the present invention. FIG. 22 schematically illustrates a door swing-limiting system 300 intended for use with a vehicle lift gate 302 that includes an automated lift gate actuator 304 (e.g. an actuator that automates opening (and potentially closing) of the lift gate). In this embodiment, the proximity sensor(s) are used to determine both the height limit and the rear distance limit by sensing the proximity of adjacent objects (such as a roof or a raised garage door for the height limit and an adjacent wall, pillar or vehicle for the rear distance limit), to calculate the degree to which the lift gate can be opened without abutting any adjacent objects, and then operate the automated actuator 304 to open the lift gate 302 only so far as permitted without abutting any adjacent objects. FIG. 23 is a schematic representation of an alternative embodiment of a door swing-limiting system 350 intended for use with driver and passenger doors 352 that are opened manually. In this embodiment, the door swing-limiting system 350 includes a motorized actuator 354 (or otherwise automated actuator) with a limited travel as the stop 356 of the door. In this embodiment, the door system 350 uses the proximity sensor to determine the position of adjacent objects that are in the swing path of the door 352, calculates the door stop 356 position that is needed to allow the door to open as far as possible without abutting adjacent objects. By adjusting the position of the actuator 354, the system 350 can vary the position of the stop 356 and consequently the opening limit of the door 352. For example, the actuator 354 may deploy a steel wedge as the door stop and the distance would vary depending on the min/max allowed travel of this actuator and wedge. If desired, the door swing-limiting system can be configured so that it never limits the door to a degree that will prevent an individual from exiting the vehicle V. For example, the actuator 354 may be configured to travel only in a range between the position needed to allow an occupant to get out of the car safely and the door wide open. When implemented, this limit increases the safety exit of the vehicle in case of failure. If desired, the actuator 354 and variable door stop 356 default to the most open position until parked then deploys as needed to limit the door open max position by deploying the stop as needed.

Additionally, or alternatively, the vehicle may use the proximity sensing system to guide parking. For example, the proximity sensing system may provide a signal when the vehicle is parked too close to an object. In one exemplary embodiment, the proximity sensing system may engage when the vehicle is moving slowly (e.g., under 3 mph) and provide an indication when there is an object too close to the driver's side of the vehicle and/or the passenger's side of the vehicle. Although not shown, the proximity sensing system may include a multicolor color LED on each side of the vehicle (e.g., opposite sides of the dashboard or opposite sides of the instrument cluster) and the LED may be illuminated to provide adjacency information, such as information regarding the proximity of nearby objects. In one embodiment, the LED may be illuminated in green to indicate there are no object in the swing of the door, yellow to indicate that an object is in the swing of the door, but there is room to open the door far enough to comfortably get out of the vehicle or red to indicate that there is an object close enough to the door to make exit from the vehicle difficult.

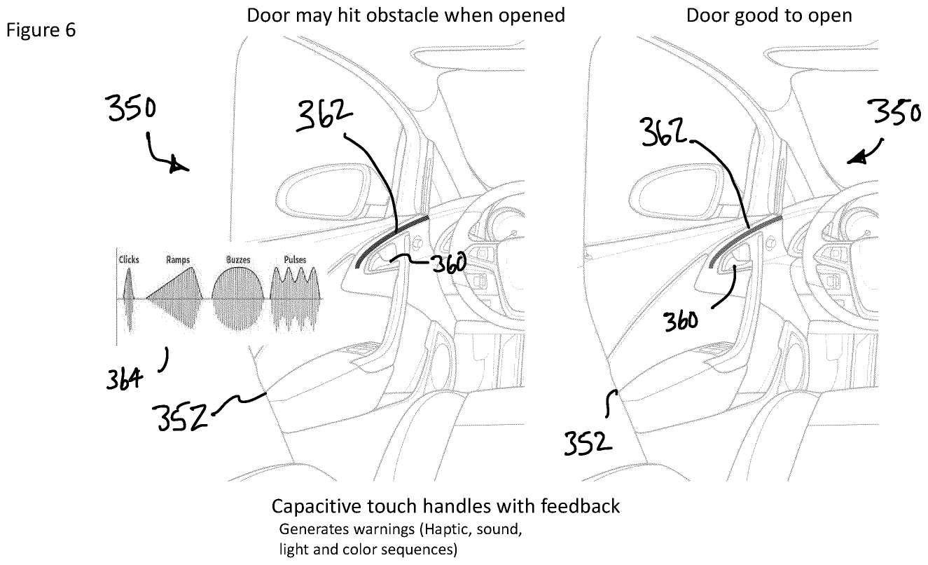

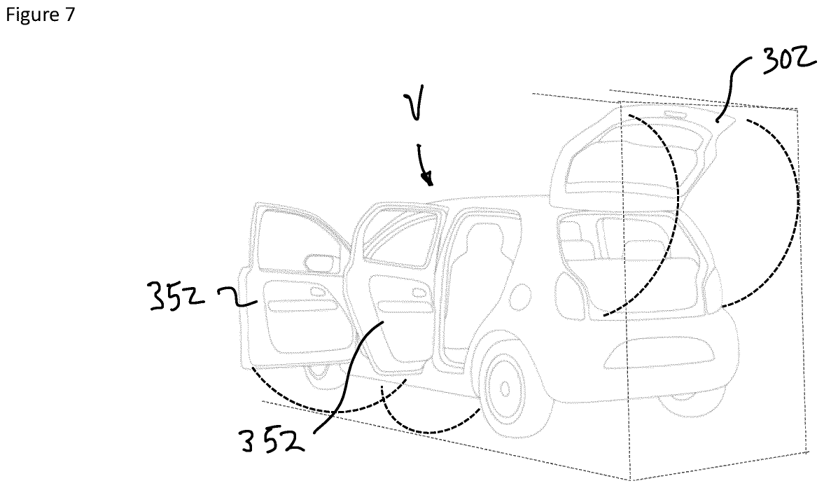

Referring now to FIG. 6, the internal door handle(s) 360 may be fitted with capacitive sensors (not shown) and with haptic feedback modules (not shown) to provide an individual with feedback on door clearance. The left portion of FIG. 6 shows feedback when there is an object in the swing of the door, and the right portion shows feedback when there are no objects in the door swing. More specifically, the door handle 360 may vibrate and an LED light strip 362 may be illuminated red when an object is in the door swing and the door handle 360 may have no haptic feedback and the LED light strip 362 may be illuminated green when the door can be freely swung open. In operation, the proximity sensing system 350 may be configured to monitor for an individual to place a hand on the internal door handle 360 using the capacitive sensor and, once contact is sensed, use the haptic feedback module to provide the individual with a haptic warning, such as those haptic signals shown in box 364. The haptic feedback pattern may vary to indicate different conditions. The magnitude and/or frequency of vibrations may vary to indicate how close an object is to the door. For example, soft and slow vibrations may be used to indicate that the door can be opened, but not fully opened, while faster and more stronger vibrations may be used to indicate that an object is close and that exit from the vehicle may be difficult. The proximity system 350 may also include visual feedback, such as variable color LEDs (See light strip 362 situated near the door handle 360). While FIG. 6 shows the proximity sensing system associated with the driver's side front door, the proximity sensing system may be configured to operate with essentially any door or liftgate as illustrated in FIG. 7.

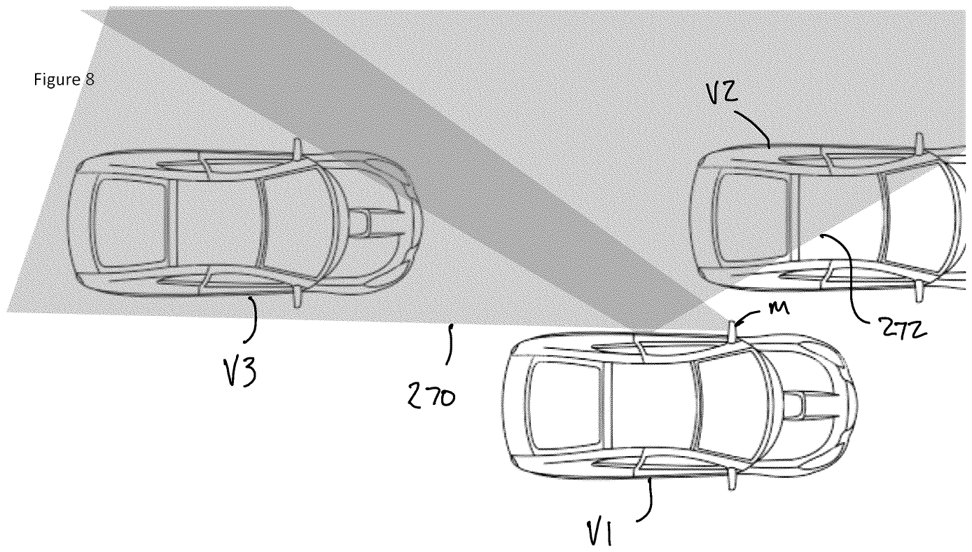

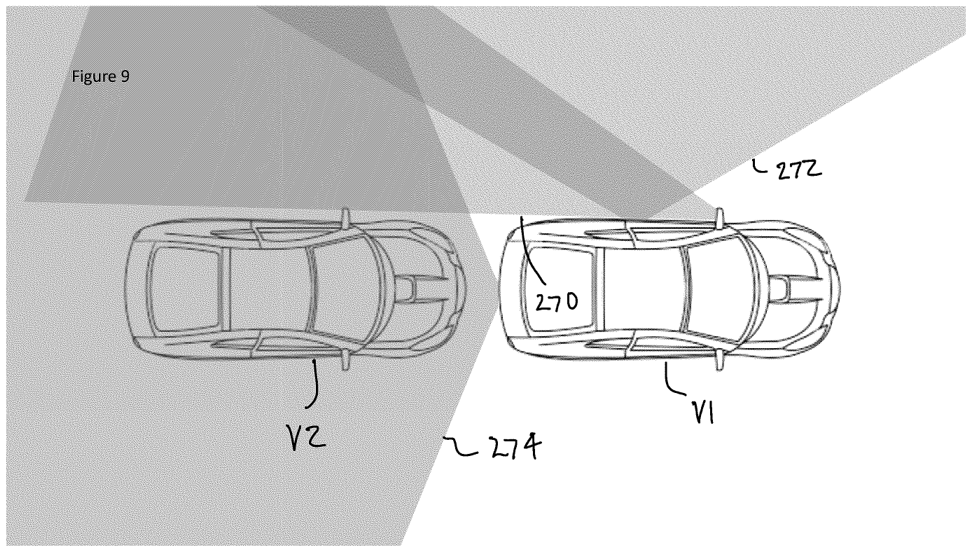

As discussed above, the keyless entry system 100 of the present invention may include a proximity sensing system, such as a radar system 250, that can operate in an entry mode to identify approaching individuals to assist in operation of the capacitive touch sensing system and in an exit mode to detect nearby objects that might interfere with opening of doors and liftgates. In some embodiments, the radar system 250 may also be configured to provide additional or alternative modes of operation. For example, as shown in FIGS. 8 and 9, the radar module(s) associated with the keyless entry system may be used when the vehicle V1 is in motion to detect oncoming and adjacent vehicles. FIG. 8 shows a vehicle V1 equipped with a radar system that is operating in detection mode to identify oncoming vehicles, approaching people and other objects that might come within range. The information obtained from the radar system can be used to understand threats approaching the vehicle when it is in motion and when it is motionless. FIG. 8 shows a first radar field 272 that is emitted by a radar antenna fitted in the door handle and a second radar field 270 that is emitted by a radar antenna installed is a side view mirror M. As illustrated, these sensors have the ability to identify vehicle V2 and V3 traveling alongside vehicle V1. FIG. 9 is an illustration showing how integration of a radar system into a capacitive touch sensor disposed in a liftgate can be used to generate radar field 274, which is able to sense object behind the vehicle V1, such as vehicle V2. In addition to detecting oncoming vehicles and approaching individuals, the rear radar module can also be used as a backup sensor to warn of approaching objects.

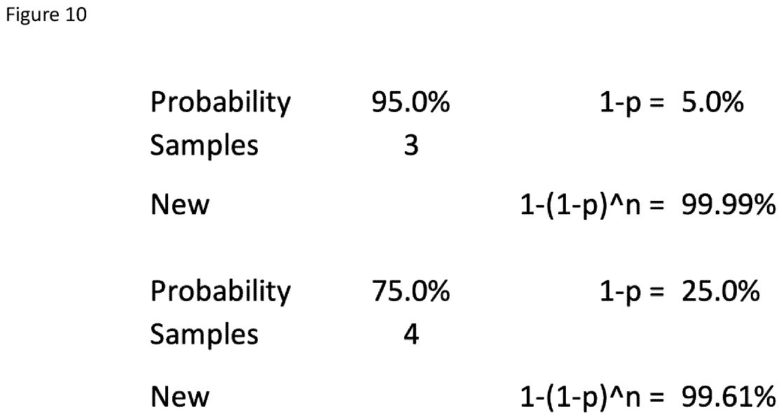

As discussed above, the control unit of the illustrated embodiment is configured to obtain and collect sensor readings over a period of time, and to analyze those readings to identify the input of a legitimate access code. In the multipoint simultaneous sensor monitoring methodology the control unit can sample multiple times. This helps to reduce noise from ice, water, gloves etc. By reading the sensor multiple times we can improve the probabilities greatly increasing the reliability of the sensor and function system. FIG. 10 provides a table reflecting the change in probability associated with increasing the number of samples. In the first example, if a single sample has a probability of 95%, then taking three sample increases the probability to 99.99%. Similarly, in the second example, if a single sample has a probability of 75%, then taking four samples increases the probability to 99.61%.

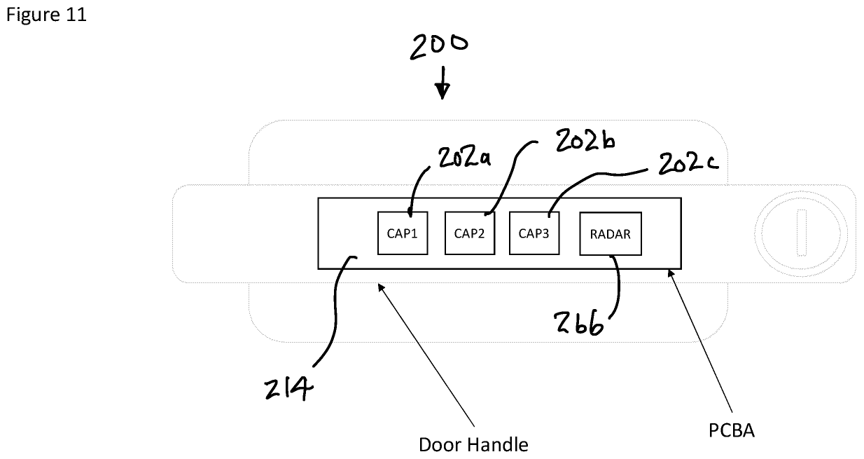

FIG. 11 shows an embodiment of the present invention in which the keyless entry system includes a single printed circuit board assembly (“PCBA”) incorporating all of the components that will be disposed at the point of entry. This approach can facilitate installation, replacement and repair. For example, in the illustrated embodiment, the PBCA includes the microcontroller (e.g. SST controller 204) that obtain and collects capacitive sensor readings from capacitive sensors 202a-c, the conductive elements that form the individual capacitive sensors and the radar module 250 with radar antenna situated behind radar window 266 (if included). In typical applications, the key FOB system will be installed separately from the keyless entry system 100 and therefore will generally not be incorporated into the keyless entry system PCBA. However, in alternative applications, the key FOB system or portions of the key FOB system may be integrated into the keyless entry system PCBA. In this embodiment, the PCBA for the keyless entry system includes the controller 110. In alternative embodiments, the same system could be implemented into an ASIC for even smaller implementation.

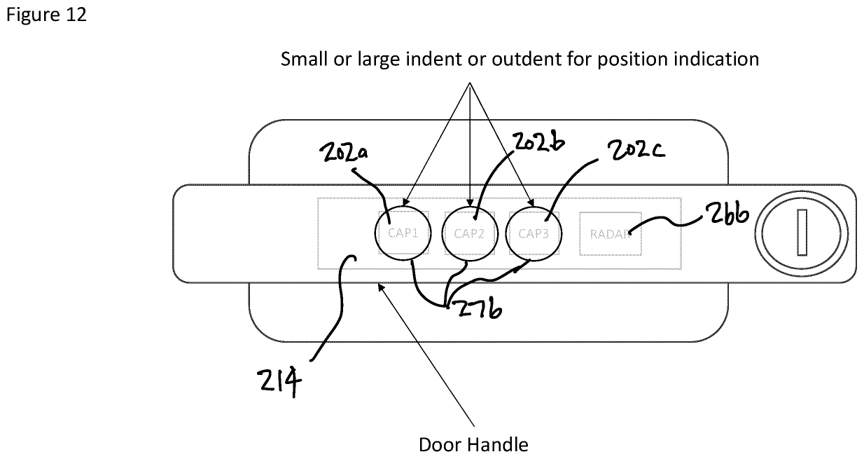

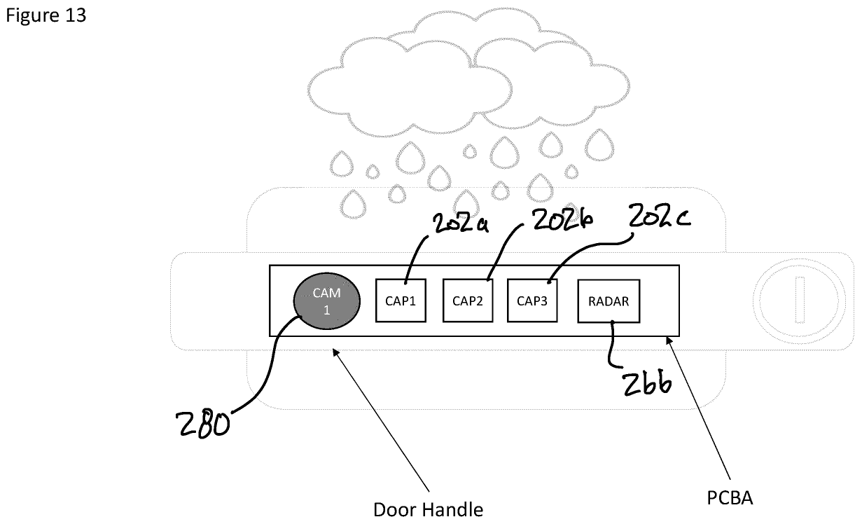

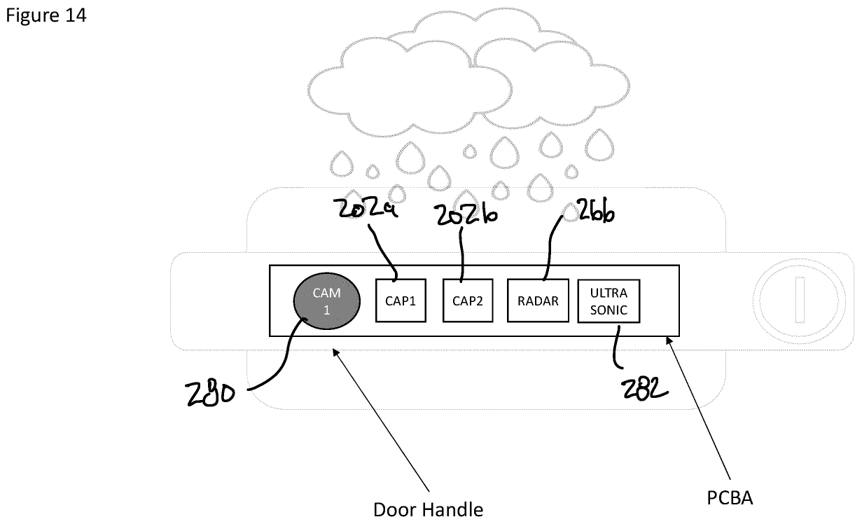

In alternative applications, the keyless entry system may include additional sensors. For example, FIG. 12 is a schematic representation of a door handle that, like the one shown in FIG. 11, incorporates three capacitive touch elements 202a-c and a radar antenna situated behind a radar window 266. In this embodiment, the touch input field 214 may include indents or outdents 276 for position indication. Although shown with a single row of three capacitive touch elements, the number and arrangement of capacitive touch elements may vary from implementation to implementation. In this example, the capacitive touch system 200 and the radar system 250 may be integrated into a single, self-contained unit that is fitted into a corresponding void in the door handle and is coupled to the vehicle by a single plug set. Power and all necessary communications may be provided through the plug set. This approach is not necessary, but it may facilitate easy installation, servicing and replacement. As another example, in the embodiment shown in FIG. 13, a keyless entry system incorporated into a door handle may include a capacitive touch system 200, a radar system 250 and a camera 280. These elements may be incorporated into a single PCBA, if desired. As discussed elsewhere, the capacitive touch elements 202a-c may be disposed on the top, inside and/or outside of the door handle. Similarly, FIG. 14 shows a keyless entry system incorporated into a door handle that includes a capacitive touch system 200, a radar system 250, a camera 280 and an ultrasonic system 282. Again, the capacitive touch elements 202a-b may be disposed on the top, inside and/or outside of the door handle.

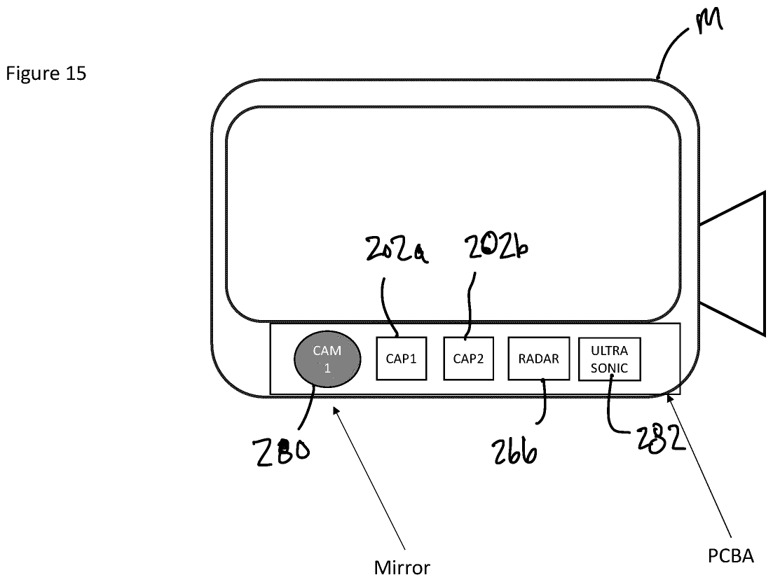

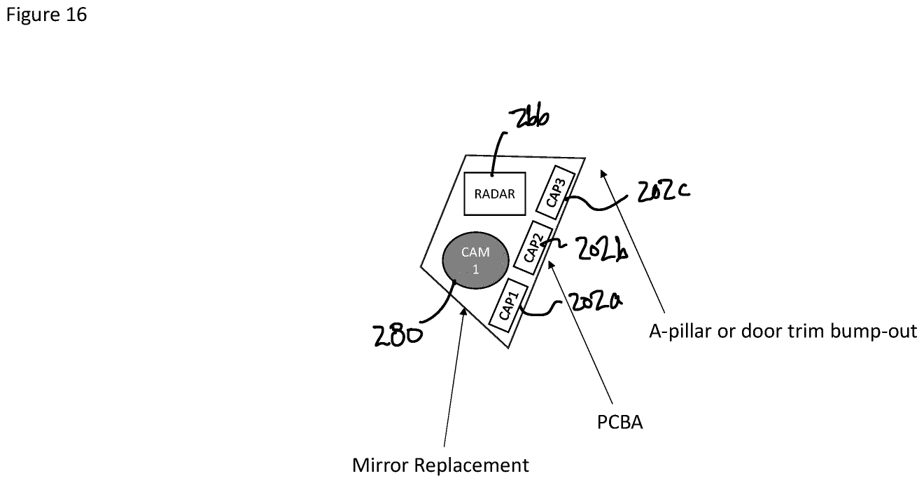

Implementations of the present invention may be incorporated into a wide variety of locations on the vehicle. FIG. 15 shows an implementation in which the keyless entry system 100 is incorporated into a vehicle side view mirror M. In this embodiment, the keyless entry system 100 may include a capacitive touch system 200, a radar system 250, a camera 280 and an ultrasonic system 282. These components may be carried on a single PCBA. FIG. 16 shows an alternative embodiment in which the keyless entry system 100 is installed in place of the side view mirror. In this embodiment, the keyless entry system 100 may include a capacitive touch system 200, a radar system 250 and a camera 280. Although not shown, the system may also include an ultrasonic system. The system may be installed, for example, in an A-pillar or door trim bump-out. The camera 280 may be used to obtain a view that generally corresponds with the view that would have been provided by a conventional side view mirror (though the view may be expanded, reduced or otherwise varied as desired). The image from the camera 280 can be displayed in essentially any desired location(s), such as in a video screen or video window provided on the dash or it may be displayed on a dedicated video screen positioned near the door pillar (e.g. the A-pillar). As with other embodiments, the touch elements may be disposed on the top, inside and/or outside of the attachment.

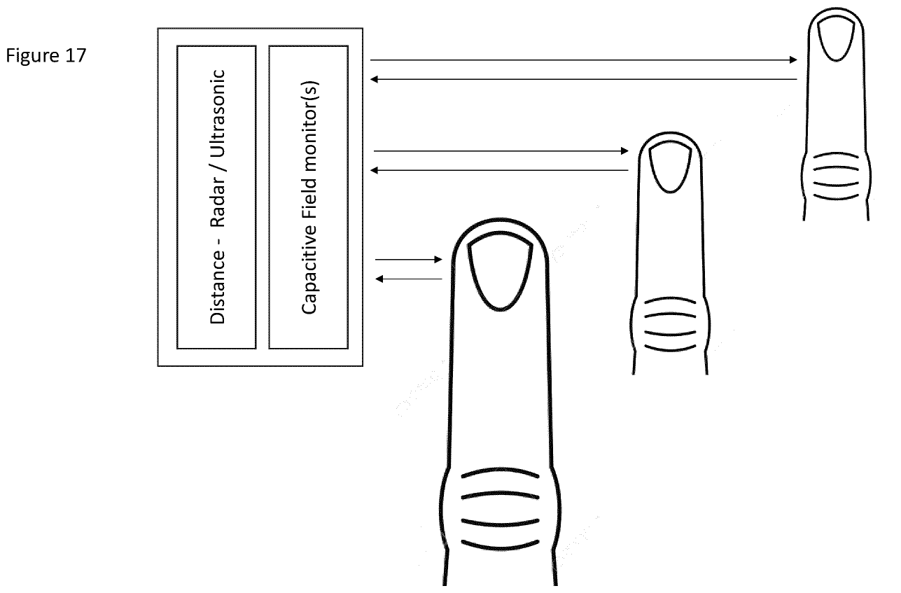

In one embodiment, the present invention provides a method for improving performance of the capacitive sensor array through calibration (See FIG. 17). In this embodiment, the capacitive sensor array is calibrated by taking readings from all of the capacitive sensor while a human finger is positioned at different touch locations on and about the capacitive touch input area. The information collected during this calibration can be readily coordinated for additional sensor fidelity.

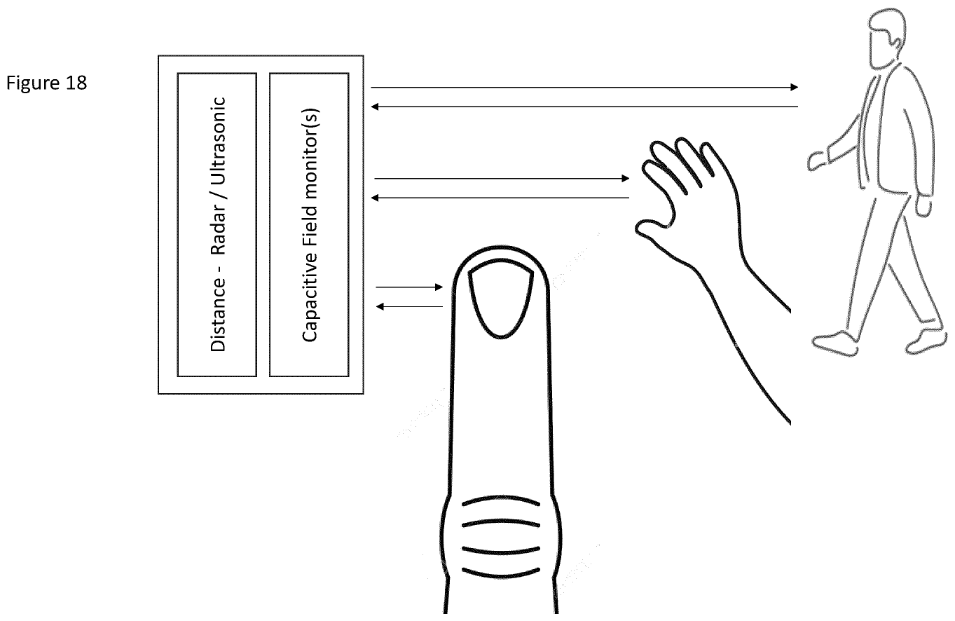

As illustrated in FIG. 18 and disclosed in connection with various embodiments of the present invention, data obtained from a plurality of different sensor systems, including capacitive touch systems, radar systems (short-range, mid-range and/or long-range radar), ultrasonic systems and/or camera systems (not shown in FIG. 18), as well as information from a key FOB system, can be used in the context of keyless entry to understand the progression of objects toward a vehicle and to provide additional information used in assessing whether a legitimate access code has been entered. For example, the keyless entry system may use these different sensors with different ranges and different power consumption characteristics to efficiently recognize a sequence of events that contributes to more efficient operation of the capacitive touch system and more accurate interpretation of capacitive touch sensor inputs. This may begin with recognition of an individual approaching the vehicle, continue with determination of when an individual is moving toward the capacitive touch sensor, and finish with accurate recognition of touch sensor inputs, including the implementation of probabilistic algorithms that allow the keyless entry system to accurately and efficiently determine whether a legitimate access code was entered even if a capacitive touch entry does not comply strictly with the expected input sequence.

In some embodiments, the control unit (e.g. SST controller 204) may be configured to implement geometric transformation algorithms on the data collected from the touch sensor array to identify touch sequences that reflect a legitimate access code even if the touch inputs do not strictly comply with the required touch sequence. While the available transformations may vary from application to application, the control unit may be configured to implement rotational transformations, scaling transformations and repositioning transformations. For example, the control unit may have the ability to scale an input sequence so that if the correct sequence was entered, but only at a bigger or smaller scale than expected, it can be interpreted as a legitimate access code entry. As another example that is more practical with larger capacitive touch sensor arrays (e.g. arrays with two or more rows of sensors), the control unit may include algorithms that effectively rotate the input sequence so that if the correct touch sequence was entered, but only at an angle to the expected sequence, it can be interpreted as a legitimate access code entry. In the illustrated embodiment, the legitimate access code and the input sequence may be represented as an array of pixels, much like an image. In some implementations, the time component associated with the input sequence is ignored and all input points are considered as occurring simultaneously solely for the purpose of implementing the desired geometrical transformation. Although the geometrical transformation algorithms may vary, in one implementation, the control unit may implement a scaling algorithm including the following general steps: (a) determining the width of the legitimate access code, (b) determine the height of the legitimate access code, (c) scaling to input sequence to have the width of the legitimate access code, and (d) scaling the input sequence to have the height of the legitimate access code. In some applications, a maximum increase and/or decrease in scale may be enforced to require the input sequence to be within an acceptable range of sizes. In one embodiment, the repositioning algorithm may include the following general steps: (a) determine the lowermost and leftmost point in the legitimate access code, (b) determine the lowermost and leftmost point in the input sequence and (c) shift the input sequence so that its lowermost and leftmost point coincides with the lowermost and leftmost point in the legitimate access code. In some applications, a maximum shift in the input sequence may be enforced to require the input sequence to be within an acceptable range of the legitimate access code. Similarly, the control unit may implement any of a variety of alternative rotation algorithms, but in one embodiment may include the following general steps: (a) use an image-processing feature detection algorithm on the legitimate access code to identify key points in both the legitimate access code and the input sequence, (b) use an image-processing feature matching algorithm to match the detected features between the legitimate access code and the input sequence, (c) use an image-processing transformation estimation algorithm to estimate the geometric rotation required to match the orientation of the input sequence to that of the legitimate access code and (d) implementing the rotation by shifting the points in the input sequence. In some applications, a maximum rotation may be enforced to require the input sequence to be within an acceptable range of the legitimate access code.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner in one or more embodiments.

What is claimed is:

1. A vehicle keyless entry system comprising:
a capacitive touch system including a plurality of capacitive touch elements arranged adjacent to a touch input region;
a control unit operatively coupled to the plurality of capacitive touch elements, the control unit configured to obtain sensor readings from each of the capacitive touch elements over time, to maintain a time-based collection of data representing the sensor readings, to analyze the data over time to determine when a legitimate touch input sequence has been entered wherein the legitimate touch input sequence incorporates at least one of multitouch inputs and swipe inputs and to initiate an action corresponding with the legitimate touch input sequence.

2. The vehicle keyless entry system of claim 1 wherein the control unit assigns an acceptable margin of error to a legitimate touch input sequence and wherein the control unit determines that a touch input sequence is legitimate if it is within the assigned margin of error.

3. The vehicle keyless entry system of claim 1 wherein the control unit is configured to determine that a legitimate touch input sequence has been entered when the sensor readings maintained in the time-based rolling data are within a margin of error of a legitimate touch input.

4. The vehicle keyless entry system of claim 1 wherein the control unit is configured to allow a user to program one or more legitimate touch input sequences by entering a touch input sequence in the touch input region during a programming mode.

5. The vehicle keyless entry system of claim 4 wherein the control unit is configured to identify a plurality of characteristics of the legitimate touch input sequence over time to use as a basis for determining the legitimacy of a touch input sequence; and
wherein the control unit is configured to determine whether a touch input sequence is a legitimate touch input by comparing the touch input sequence with the identified plurality of characteristics of the legitimate touch input sequence.

6. The vehicle keyless entry system of claim 5 wherein the vehicle keyless entry system includes a proximity sensor; and
wherein the control unit is configured to periodically obtain sensor readings from the proximity sensor to determine when an individual is approaching a vehicle in which the keyless entry system is installed, and to begin obtaining capacitive touch sensor readings based on a determination that an individual is approaching the vehicle.

7. The vehicle keyless entry system of claim 6 wherein the control system is configured to operate in an object detection mode in which the control system obtains sensor readings from the proximity sensor to determine whether an object is present outside a vehicle in which the keyless entry system is installed.

8. The vehicle keyless entry system of claim 7 wherein the proximity sensor is at least one of an ultrasound transducer or a radar antenna.

9. The vehicle keyless entry system of claim 1 wherein the control unit is capable of normalizing a touch input sequence by performing at least one geometric transformation on a touch input sequence.

10. The vehicle keyless entry system of claim 9 wherein the geometric transformation includes at least one of scaling, shifting and rotation of the touch input sequence.

11. A vehicle keyless entry system comprising:
a capacitive touch system including a plurality of capacitive touch elements arranged adjacent to a touch input region;
a proximity sensor system including a proximity sensor capable of providing sensor readings representative of objects adjacent to a vehicle;
a control unit operatively coupled to the plurality of capacitive touch elements and the proximity sensor, the control unit configured to:
periodically obtain sensor readings from each of the capacitive touch elements and to maintain a time-based collection of data from each of the capacitive touch elements;
periodically obtain sensor readings from the proximity sensor; and
analyze the sensor readings from the capacitive touch elements and the proximity sensor to perform action associated with the keyless entry system;
a plug set for coupling the keyless entry system to existing electronics in a vehicle to facilitate operation of vehicle electronics by the keyless entry system;
wherein the capacitive touch system, proximity sensor system, control unit and plug set are integrated into a single module that can be readily installed into a single mounting location on a vehicle.

12. The vehicle keyless entry system of claim 11 further including a touch input area, the capacitive touch elements being positioned adjacent the touch input area.

13. The vehicle keyless entry system of claim 12 wherein the touch input area includes indicia associated with each of the capacitive touch elements.

14. The vehicle keyless entry system of claim 13 wherein the capacitive touch sensors include at least five capacitive touch sensors arranged in a row across the touch input area.

15. The vehicle keyless entry system of claim 14 wherein the capacitive touch sensors include at least ten capacitive touch sensors arranged in two generally parallel rows across the touch input area.

16. The vehicle keyless entry system of claim 11 wherein the proximity sensor includes at least one of an ultrasound transducer and a radar antenna.

17. The vehicle keyless entry system of claim 16 further including a camera, the camera being incorporated into the single module and utilizing the plug set.

18. The vehicle keyless entry system of claim 13 wherein the single module includes a single printed circuit board assembly.

19. The vehicle keyless entry system of claim 18 wherein the single module is incorporated into a vehicle badge configured to mount to a vehicle at a desired location.

20. The vehicle keyless entry system of claim 18 wherein the single module is incorporated into a vehicle trim element configured to mount to a vehicle as a trim element.
